(19) United States
(12) Patent Application Publication
(10) Pub. No.: US 2006/0169257 A1
(43) Pub. Date: Aug. 3, 2006

(54) High compression pistons having vanes or channels

(76) Inventor: John C. Ziehl, Allegan, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/045,839

(22) Filed: Jan. 28, 2005

(51) Int. Cl. F02B 23/00

(52) U.S. Cl. 123/659

(57) ABSTRACT

A four-stroke internal combustion engine includes a piston having a channel or channels extending between each intake port and an exhaust port to provide a flow path that directs air from the intake port to the exhaust port without inducing turbulence. The channels allow laminar flow from an intake port to an exhaust port during the cam overlap period to improve scavenging. Vanes may be included in the channels to further enhance laminar flow and provide better scavenging during an overlap period at the end of the exhaust stroke and/or the beginning of the intake stroke. This arrangement reduces dilution of the air/fuel mixture and provides improved combustion efficiency and power output.

### FIELD OF THE INVENTION

This invention relates to internal combustion engines, and more particularly to an improved piston design for four-stroke internal combustion engines.

### BACKGROUND OF THE INVENTION

In a modern four-stroke engine, there is a brief period between the end of an exhaust stroke and the beginning of an intake stroke when the camshaft actually has both the intake and exhaust valves slightly open simultaneously. This period of cam timing is referred to as “overlap.” During the overlap period, a properly designed and properly functioning exhaust system draws exhaust gases to creating negative pressure at the exhaust port. This causes a sweeping flow of a mixture of fresh fuel and air from the intake port towards the exhaust port. This flow removes remnant portions of the exhaust gases from the cylinder, thereby reducing dilution of the fresh air/fuel mixture. This effect is referred to as “scavenging,” since the combustion chamber becomes scavenged or swept clean of burnt gases. This scavenging effect can also create a condition of lower than atmospheric pressure (vacuum) in the combustion chamber before the piston begins its downward intake stroke, thus aiding in initiating the flow of the fuel/air mixture into the cylinder from the intake port.

Known four-stroke engine designs have not fully optimized piston configuration to maximize scavenging during the overlap period.

U.S. Pat. No. 6,615,789 to Inoue et al. discloses a piston for an internal combustion engine. The piston includes a crown having a central axis, and a piston bowl disposed in the piston crown, on which two tumble flows of air are provided. The piston bowl has a generally V-shaped contour in section taken along a vertical plane intersecting the tumble flows, on which the two tumble flows are retained at an inclined state toward a central axis of the piston crown. The piston bowl is said to create strong turbulence that entrains the fuel spray injected at the late stage of the compression stroke so that improved combustion can be achieved. The particular design of the piston bowl allows tumbles flows to be stably retained at the inclined state so that a stable stream and turbulence of the tumble flows can be produced to reduce cycle variation of flow velocity or turbulence of the tumble flows relative to tumble strength.

U.S. Patent Application Publication No. 2004/0003793 discloses a piston for an internal combustion engine having an intake port through which intake air is introduced into the cylinder in a way as to produce a swirl that travels along while whirling about an axis transverse to an axis of the cylinder. The piston has a crown face with a cavity having a partially cylindrical bottom. The cavity has a longitudinal center axis extending obliquely to a crank axis so that the longitudinal center axis of the cavity nearly coincides with an axis along which the swirl travels within the cylinder. The arrangement is said to generate a strong swirl within the cylinder and improve combustion efficiency.

U.S. Pat. No. 5,309,879 to Regueiro discloses a four valve, double overhead camshaft diesel engine having a precombustion chamber with an angled and tapered transfer passage leading to the main combustion chamber. The piston has a domed upper surface with recessed lobes. Each recessed lobe functions as a valve pocket for the intake and exhaust valves. It is stated that the combination of the side pre-combustion chamber, piston with recessed valve receiving pockets and multivalve porting of each cylinder provides a diesel engine which can be easily modified to provide improved startabiltiy, driveability, noise and emissions.

U.S. Pat. No. 4,162,661 to Nakanishi et al. discloses an internal combustion engine with combustion chambers that create a swirl of an air/fuel mixture. Specifically, the engine has an inner wall of a cylinder head and a top end of a piston provided with at least two projected regions defining gaps for creating swirl of the air/fuel mixture toward the end of the compression stroke of the piston. This arrangement is said to provide turbulence of a air/fuel mixture in the combustion chamber and move any cold air/fuel mixture which is stagnated on the surface of the top end of the piston, whereby improve combustion efficiency, reduced emissions, and improved engine output power are achieved.

Generally, the various arrangements of the prior art are intended to provide indentations, cavities, recesses or lobes that induce swirling and cause turbulence to achieve uniform mixing of the air and fuel. These various attempts do not specifically address scavenging during the overlap period, and do not provide structure that optimizes and fully exploits the scavenging effect.

### SUMMARY OF THE INVENTION

The invention takes advantage of the function that the piston plays during the overlap period. During this portion of cam timing, the piston is actually forming the bottom of a flow path between the intake and exhaust valves. It is effectively the base of a manifold. Unlike the prior art which discloses various turbulence inducing features on the surface of a piston which faces the combustion chamber of an engine, the invention provides features that allow a more laminar flow from the intake port to the exhaust port. Less turbulence allows a higher mass flow rate from the intake port to the exhaust port during the overlap period thereby enhancing scavenging.

In accordance with an aspect of the invention, a four-stroke internal combustion engine includes an engine block having a cylinder bore extending through the engine block, and a cylinder head having an intake port with an intake valve and an exhaust port with an exhaust valve. The cylinder head is secured to the engine block to define a combustion chamber. A piston reciprocates in the cylinder bore and has an upper surface facing the intake valve and exhaust valve. A channel extends across an upper surface of the piston along a direction generally between the intake port and the exhaust port.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a vertical cross section of an internal combustion engine in accordance with an embodiment of the invention.

FIG. 2 is an enlarged side elevational view of the piston shown in the engine of FIG. 1.

FIG. 3 is a schematic top view of the piston shown in FIG. 2 with the location of the intake valves and exhaust valves of a four valve per cylinder engine arrangement superimposed on the piston.

FIG. 4 is a side elevation view of a piston in accordance with an alternative embodiment of the invention.

FIG. 5 is a schematic top view of the piston shown in FIG. 4 with the location of the intake valves and exhaust valves of a four valve per cylinder engine arrangement superimposed on the piston.

FIG. 6 is a side elevational view of a piston in accordance with a further alternative embodiment of the invention.

FIG. 7 is a schematic top view of the piston shown in FIG. 6 with the position of the intake valves and exhaust valves of a four valve per cylinder engine arrangement superimposed on the piston.

FIG. 8 is a schematic top view of an alternative embodiment of the invention with the positions of the intake valves and exhaust valves of a five valve per cylinder engine arrangement superimposed on the piston.

### DESCRIPTION OF PREFERRED EMBODIMENTS

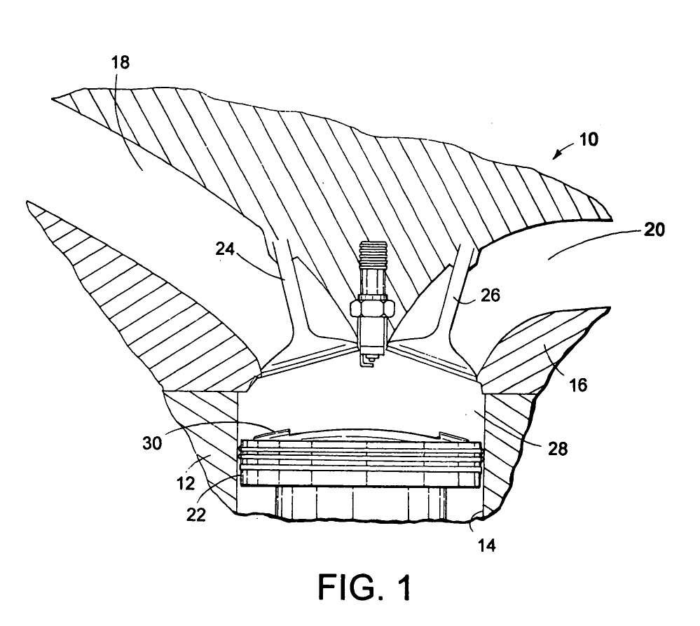

Shown in FIG. 1 is a fragmentary view of a typical four-stroke internal combustion engine 10. A cylinder of the combustion engine is defined by an engine block 12 having a cylindrical bore 14, and a cylinder head 16 defining at least one intake port 18 and one exhaust port 20. A piston 22 reciprocates within the cylindrical bore 14. Shown somewhat schematically is an intake valve 24 and an exhaust valve 26. Opening and closing of valves 24 and 26 are timed or coordinated to the reciprocating movement of piston 22. Typically, this is achieved by a rotating camshaft (not shown) having cam surfaces that engage rocker arms (not shown) linked to valve 24 and 26. Rotation of the camshaft, and thus valve opening and closing, is typically coordinated or synchronized with rotation of the camshaft which is mechanically linked to the piston by a connecting rod, by means of a timing belt or chain. A combustion chamber 28 is generally defined by the walls of the cylindrical bore 14, cylinder head 16, along with valves 24 and 26, and the upper surface or crown 30 of piston 22.

While the principles of the invention may be employed with various four-stroke cylinder configurations, the benefits and advantages of the invention are believed to be most notable when employed with engines having a semi-hemi combustion chamber, i.e., engines wherein the cylinder head has a concave, generally hemispherical shape. However, the concepts of the invention may also be employed with other engine designs including pentroof, flat, semi-hemi and pancake cylinder head designs.

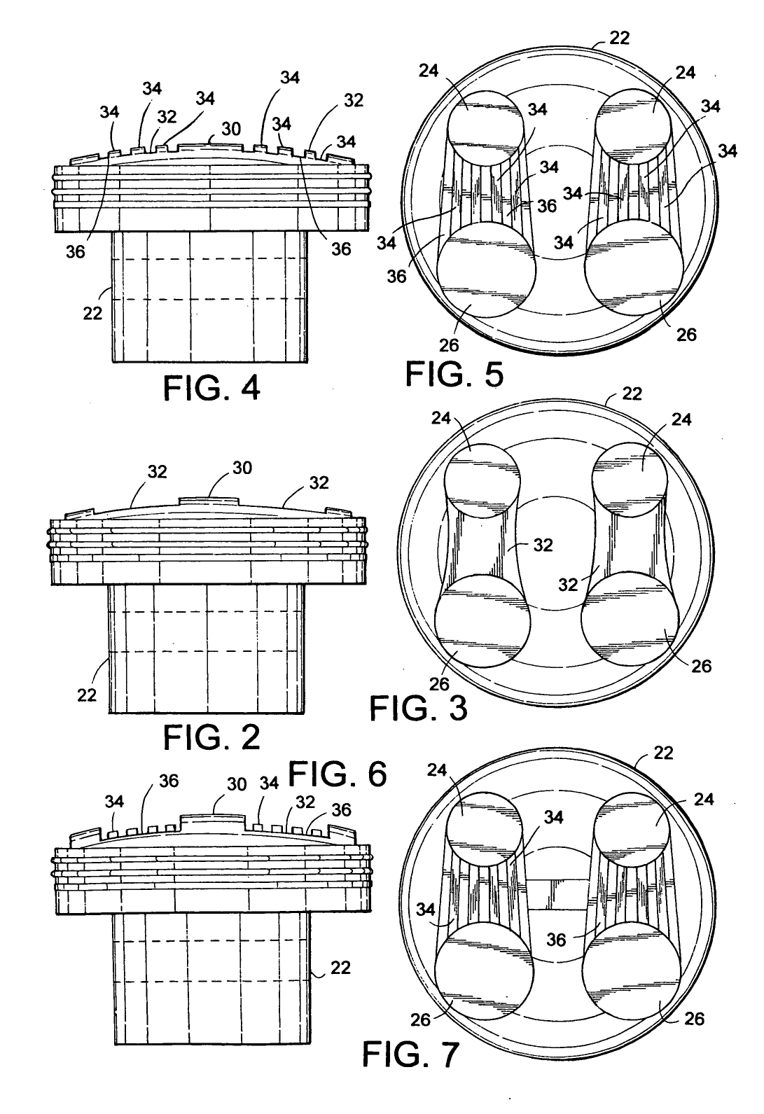

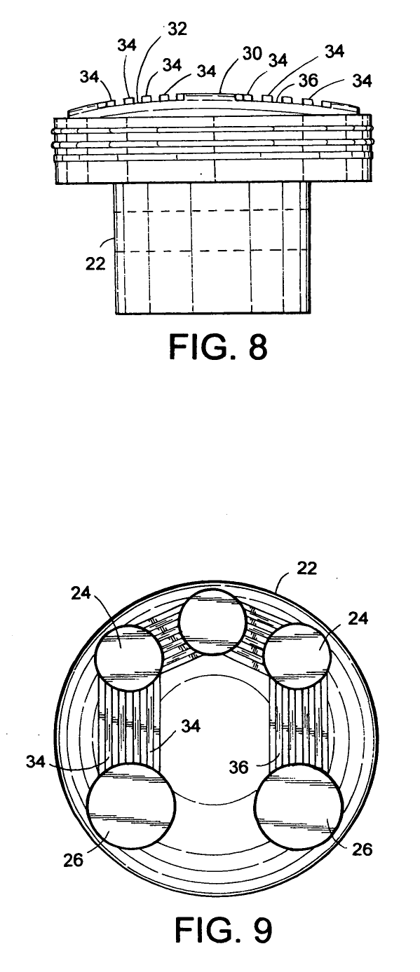

Further, the principles of the invention may be employed with engines having two, four, five or six valves per cylinder. FIG. 1 shows only two valves, one intake valve 24 and one exhaust valve 26. A typical four valve per cylinder arrangement is shown in FIGS. 3, 5 and 7. Typically, the roof of the combustion chamber (i.e., cylinder head 16) can be divided into four quadrants, with a port and associated valve located within each of the four quadrants in a four valve per cylinder arrangement. However, the principles of the invention may be employed with various other valve arrangements such as the five valve per cylinder arrangement illustrated schematically in FIG. 8. In this arrangement, an additional intake port and valve is centered at the top of cylinder head 16 above piston 22.

In the case of engines having a hemispherical combustion chamber, piston 22 typically has an upper surface or crown 30 facing toward the combustion chamber which has a generally convex hemispherical shape that substantially conforms with the concave hemispherical shape of the roof of the combustion chamber.

Rather than providing pockets, baffles or the like to the piston crown to increase turbulence, as is well known in the art, the invention employs channels or vanes that create a laminar flow of air which reduces turbulence and allows air to flow more quickly from the intake port to the exhaust port during the overlap to facilitate improved scavenging of remnant exhaust gases. The laminar flow also reduces mixing of the air/fuel mixture with the remnant exhaust gases, thereby reducing dilution of the air/fuel mixture with exhaust gases. This in turn provides improved combustion, reduced undesirable emissions, and greater power.

FIGS. 2 and 3 illustrate one embodiment of the invention wherein channels 32 are recessed into convex hemispherical crown 30 of piston 22 to direct or channel air from the intake ports to the exhaust ports of an engine having a four valve per cylinder configuration. Specifically, each channel extends across the upper surface or crown 30 of piston 22, generally along a straight path from an intake valve 24 to an exhaust valve 26. Channels 32 may be straight or may have a venturi type shape as shown in FIG. 3. In general, channels 32 are not any wider than the diameters of the ports that the channels extend between.

It is advantageous to have the parts of the piston top not devoted to the “channels” to be as conformal as possible to the recesses of the cylinder head. This will reduce the dampening effect of having combustion chamber volume not devoted to the channels, and improve combustion efficiency.

Shown in FIG. 4 is an alternative embodiment in which vanes 34 are disposed lengthwise within channels 32 to provide a series of generally parallel small channels that extend between ports 24 and 26. It is believed that this arrangement further reduces turbulence and further enhances scavenging and hence combustion efficiency and power output. Vanes 34 in FIG. 4 have a height or depth that is about equal to the depth of channel 32.

In a further alternative embodiment shown in FIG. 6, vanes 34 have a height or depth that is less than the depth of recess 32. In the illustrated embodiment, the height or depth of vanes 34 is about half of the depth of channel 32. This arrangement is a hybrid configuration of those shown in FIGS. 2 and 4, with vanes 34 providing a more laminar flow than a vane-less channel, while the reduced height of vanes 34 of the embodiment of FIG. 6 allows a higher flow of air, as compared with the embodiment of FIG. 4, due to the greater cross sectional area for flow.

With the five valve arrangement shown in FIG. 8, two exhaust ports and their associated valves 26 are located near the outer circumference of the cylinder and are radially spaced apart by about 90° with respect to the cylinder axis, and two intake ports and their associated valves 24 are also located near the outer circumference of the cylinder and are radially disposed about 90° from each other and from an adjacent intake port and its associated valve 26. Channels 32 (which may or may not include vanes 34) extend approximately linearly between adjacent pairs of inlet and outlet ports. In addition, channels 32 may also extend linearly from the center port and its associated valve 24 to the outlet ports and their associated valves 26. Similarly, the use of channels and vanes in accordance with the principles of the invention may be employed on other engine designs such as six valve per cylinder designs.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the doctrine of equivalents.

The invention claimed is:

1. A four-stroke internal combustion engine, comprising:
an engine block having a cylinder bore extending through the engine block;
a cylinder head having an intake port and an associated intake valve, and an exhaust port and an associated exhaust valve, the cylinder head being secured to the engine block to define a combustion chamber; and
a piston that reciprocates in the cylinder bore, the piston having an upper surface facing the intake valve and exhaust valve, a channel extending across the upper surface of the piston along a generally straight path between the intake port and the exhaust port.

2. The engine of claim 1, wherein the cylinder head defines a combustion chamber having a concave hemispherical roof.

3. The engine of claim 1, wherein the cylinder head defines a combustion chamber having a semi-hemi or pancake design.

4. The engine of claim 3, wherein the vane has a height about equal to the depth of the channel.

5. The engine of claim 4, wherein the vane has a height less than the depth of the channel.

6. The engine of claim 5, wherein the height of the vane is about half the depth of the channel.

7. The engine of claim 1, further comprising a second intake port and a second exhaust port, and a second channel extending between the second intake port and the second exhaust port.

8. The engine of claim 1, further comprising a second and third intake port, and a second exhaust port, and having at least one channel extending from each intake port to an exhaust port.

9. The engine of claim 1, further comprising at least one vane extending along the length of the channel.

10. The engine of claim 9, wherein the upper surface of the piston has a convex hemispherical shape generally conforming with the concave hemispherical shape of the roof of the combustion chamber.

11. The engine of claim 1, wherein the channel has a venturi shape.
